(19) United States
(12) Patent Application Publication
(10) Pub. No.: US 2011/0241607 A1
(43) Pub. Date: Oct. 6, 2011

(54) ELECTRONIC DEVICE WITH INTEGRAL INDUCTIVE CHARGING STATION

(75) Inventor: Michael R. Wiegers, Baldwin City, KS (US)

(73) Assignee: GARMIN LTD., Camana Bay (KY)

(21) Appl. No.: 12/754,728

(22) Filed: Apr. 6, 2010

(51) Int. Cl. H02J 7/00

(52) U.S. Cl. 320/108

(57) ABSTRACT

An inductive charging station that does not have to be directly plugged into an electrical socket in order to recharge a battery of an electronic device. The inductive charging station is incorporated into a primary electronic device, such as a laptop computer, for charging or recharging a secondary electronic device, such as a mobile phone. The inductive charging station is electrically coupled with the power source of the primary electronic device so that it may be used to inductively charge the battery of the secondary electronic device without directly plugging either the inductive charging station or the secondary electronic device into an electrical socket or other source of electricity.

### BACKGROUND

Many portable electronic devices such as cell phones and portable navigation devices have rechargeable batteries. Rechargeable batteries are typically recharged conductively via an AC adapter cable that plugs into a device's power input contacts or connection from a USB port on a computer. Conductive charging of batteries is sometimes undesirable because water or contaminants may come into contact with the device's power contacts. Conductive charging is also often inconvenient because it requires a user to carry the requisite adapter with them and then plug the adapter into the electronic device.

### SUMMARY

Embodiments of the present technology provide an inductive charging station that does not have to be directly plugged into an electrical socket in order to recharge a battery of an electronic device. An exemplary embodiment which implements the technology includes a primary electronic device such as a laptop computer, computer monitor, television, etc. and a secondary electronic device with a rechargeable battery such as a cell phone or portable navigation device. The inductive charging station is integrated in and powered by the primary electronic device so that it does not have to be directly plugged into an electrical socket. The secondary electronic device includes an inductive charger that charges its rechargeable battery when it is in the vicinity of the inductive charging station of the primary electronic device. With this configuration, the battery of the secondary electric device may be charged or recharged by simply placing the secondary electronic device on or in the vicinity of the inductive charging station of the primary electronic device without directly plugging either the inductive charging station or the secondary electronic device into an electrical socket or other source of electricity. In some embodiments, the primary electronic device includes an internal source of power such as batteries and/or a solar cell, so even the primary electronic device does not have to be plugged into an external source of electricity in order to inductively charge the secondary electronic device. Moreover, the primary electronic device may also be used for other purposes, so a dedicated, stand-alone inductive charging station is not required.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present technology will be apparent from the following detailed description of the embodiments and the accompanying drawing figures.

### BRIEF DESCRIPTION OF THE DRAWING FIGURES

Embodiments of the present technology are described in detail below with reference to the attached drawing figures, wherein:

FIG. 1 is a perspective view of a primary electronic device and a secondary electronic device constructed in accordance with embodiments of the present technology and showing the secondary electronic device removed from the primary electronic device;

FIG. 2 is a perspective view of the primary and secondary electronic devices of FIG. 1 showing the secondary electronic device being charged by the primary electronic device;

FIG. 3 is a perspective view of a primary electronic device and a secondary electronic device constructed in accordance with other embodiments of the present technology and showing the secondary electronic device being charged by the primary electronic device;

FIG. 4 is a block diagram illustrating certain components of the primary electronic device of FIG. 1 and the primary electronic device of FIG. 3;

FIG. 5 is a block diagram illustrating certain components of the secondary electronic device of FIG. 1 and FIG. 3; and

FIG. 6 is a block diagram illustrating certain components of the inductive charging station of the primary electronic device and the inductive charger of the secondary electronic device.

The drawing figures do not limit the embodiments of the present invention to the specific embodiments disclosed and described herein. The drawings are not necessarily to scale, emphasis instead being placed upon clearly illustrating the principles of the technology.

### DETAILED DESCRIPTION

The following detailed description of various embodiments of the present technology references the accompanying drawings which illustrate specific embodiments in which the technology can be practiced. The embodiments are intended to describe aspects of the technology in sufficient detail to enable those skilled in the art to practice them. Other embodiments can be utilized and changes can be made without departing from the scope of the technology. The following detailed description is, therefore, not to be taken in a limiting sense. The scope of the present technology is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

In general, embodiments of the technology relate to an inductive charging station that does not have to be directly plugged into an electrical socket or other source of power in order to recharge a battery of an electronic device. An exemplary embodiment which implements the technology includes a primary electronic device in which the inductive charging station is integrated and a secondary electronic device with one or more rechargeable batteries that may be inductively charged or recharged by the inductive charging station. The primary electronic device may be a laptop computer, a desktop computer, a notepad computer, a television, a computer monitor, a media player, or any similar device, and the secondary electronic device may be a portable navigation device, a mobile phone, a portable media player, a mobile internet device, or any other portable device with rechargeable batteries. Advantageously, the inductive charging station is electrically coupled with the primary electronic device's internal power source so the charging station does not have to be directly plugged into an electrical socket. With this configuration, the inductive charging station of the primary electronic device may be used to charge the battery of the secondary electronic device without directly plugging the inductive charging station or the secondary electronic device into an electrical socket. Thus, the primary electronic device functions both as a computer, television, monitor, media player, etc. and as a recharging station for the secondary electronic device.

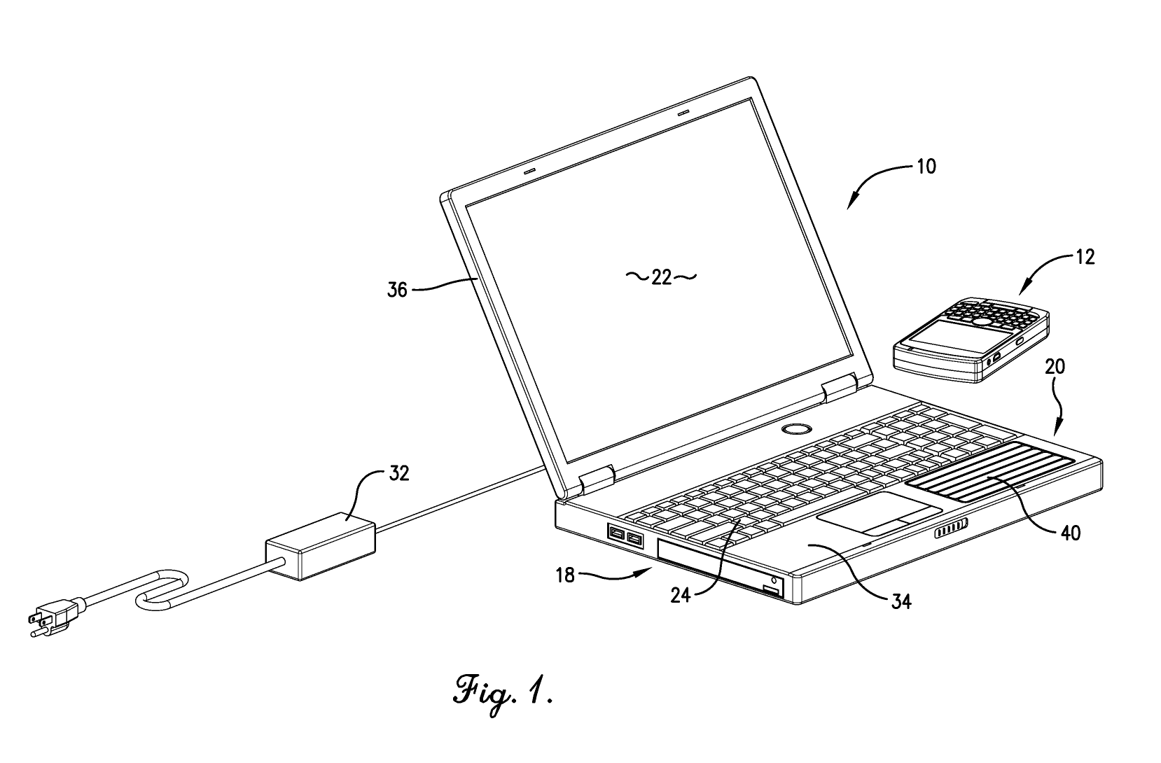

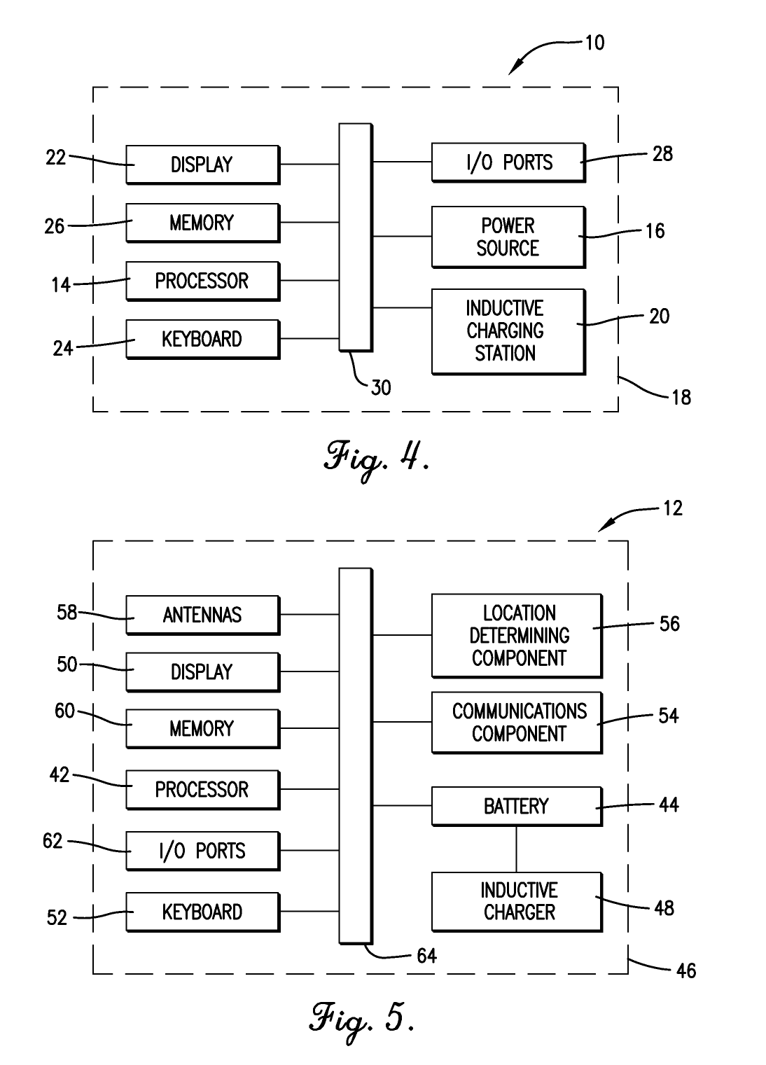

Exemplary embodiments of the primary electronic device 10 and the secondary electronic device 12 are illustrated and described in more detail with reference to the drawing figures and initially FIGS. 1, 4, and 5. Turning initially to FIG. 4, embodiments of the primary electronic device 10 may comprise one or more processors 14 and/or other electronic circuitry for executing logical and mathematical operations on data; a power source 16 for powering the electronic circuitry and other components of the electronic device 10; a housing 18 for enclosing or supporting the other components of the primary electronic device 10; and an inductive charging station 20 integrally formed with or otherwise attached to the housing 18. The primary electronic device 10 may also comprise a display 22; a keyboard 24 or other user interface; one or more memory elements 26; one or more input/output (I/O) ports 28; and/or other components.

The processor 14 may be any electronic device or component capable of executing logical and mathematical operations on data. The processor 14 may be a single electronic component or it may be a combination of components that provide the requisite functionality. The processor 14 may comprise microprocessors, microcontrollers, programmable logic controllers (PLCs), field-programmable gate arrays (FPGAs), application specific integrated circuits (ASICs), or any other component or components that are operable to perform, or assist in the performance of, the required operations. The processor 14 may be coupled with other components of the primary electronic device 10 through wired or wireless connections, such as a data bus 30, to enable information to be exchanged between the various components. However, the components of the primary electronic device 10 need not be physically connected to one another since wireless communication among the various depicted components is permissible and intended to fall within the scope of the present invention.

The power source 16 provides electrical power to the inductive charging station 20 and the other components of the primary electronic device 10 and may comprise conventional power supply elements such as batteries, battery packs, power conduits, connectors, and receptacles operable to receive batteries, battery connectors, or power cables. The power source may also include one or more solar cells or other renewable energy collectors. In embodiments where the power source includes batteries, the batteries may comprise any type of rechargeable battery or batteries including lead acid, nickel cadmium (NiCad), nickel metal hydride (NiMHi), lithium ion (Li-ion) or lithium ion polymer (Li-ion polymer) batteries. In some embodiments, the power source 16 may include both an internal rechargeable battery and/or solar cell to enable portable operation and a power adapter cable 32 for receiving power from an external source such as an electrical outlet. The housing 18 may be compact, lightweight, and/or otherwise portable to facilitate easy transport of the primary electronic device 10 or may be large and relatively heavy so as to be permanently or semi-permanently mounted or otherwise positioned on a desk, countertop, or other support surface. The housing 18 may be constructed from a suitable lightweight and impact-resistant material such as, for example, plastic, nylon, aluminum, or any combination thereof and may include one or more appropriate gaskets or seals to make it substantially waterproof or resistant. The housing 18 may take any suitable shape or size, and the particular size, weight and configuration of the housing may be changed without departing from the scope of the present invention.

In some embodiments, the housing 18 may include a base 34 hingedly connected to a cover 36 in a clam-shell arrangement as illustrated in FIGS. 1-3. The inductive charging station 20 may be integrated in or otherwise attached to either the base 34 or the cover 36 as described in more detail below.

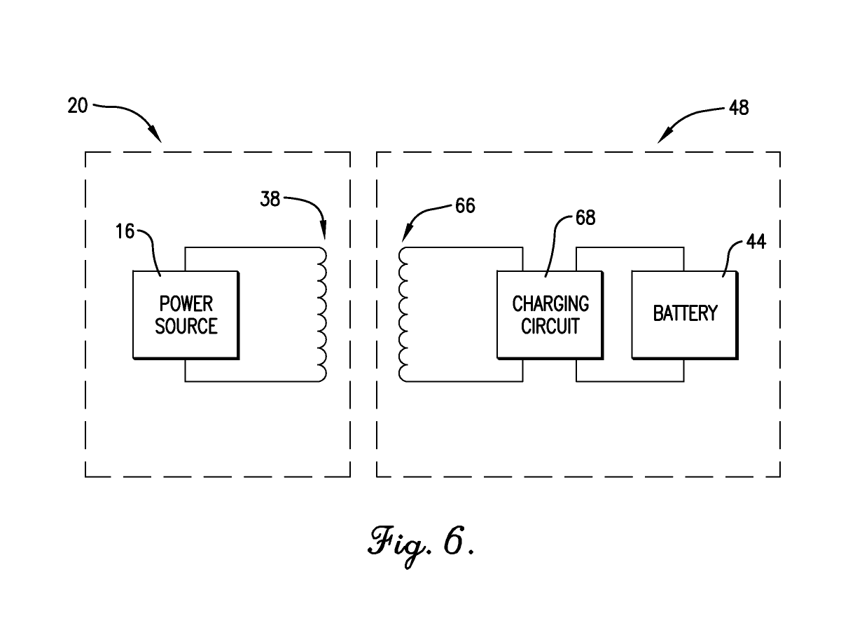

The inductive charging station 20 is provided for inductively charging the secondary electronic device 12 or similar devices and is built into or otherwise attached to the housing 18 of the primary electronic device 10. As best illustrated in FIGS. 1 and 6, the inductive charging station 20 may include a primary inductive coil 38 that is connected to the power source 16 of the primary electronic device 10 and a pad 40 that covers the primary inductive coil 38 and provides a surface on which the secondary electronic device 12 may be placed for charging. The inductive charging station 20 may also include one or more capacitors coupled in series and/or parallel with the primary inductive coil 38 to form an LC circuit. The inductance value of the primary inductive coil 38 and the capacitance value of the capacitor or capacitors may be selected to achieve a desired resonant frequency matched to the frequency of the power source 16, but the present technology is not limited to any particular inductance and/or capacitance values and/or any particular power source ratings.

The pad 40 may be of any size and shape, and in one embodiment is approximately 3-4″ long and 2-3″ wide to accommodate a typically sized mobile phone or portable navigation device. The pad 40 may be formed of any suitable material and may have a non-skid surface to frictionally engage the secondary electronic device 12 while it is being charged.

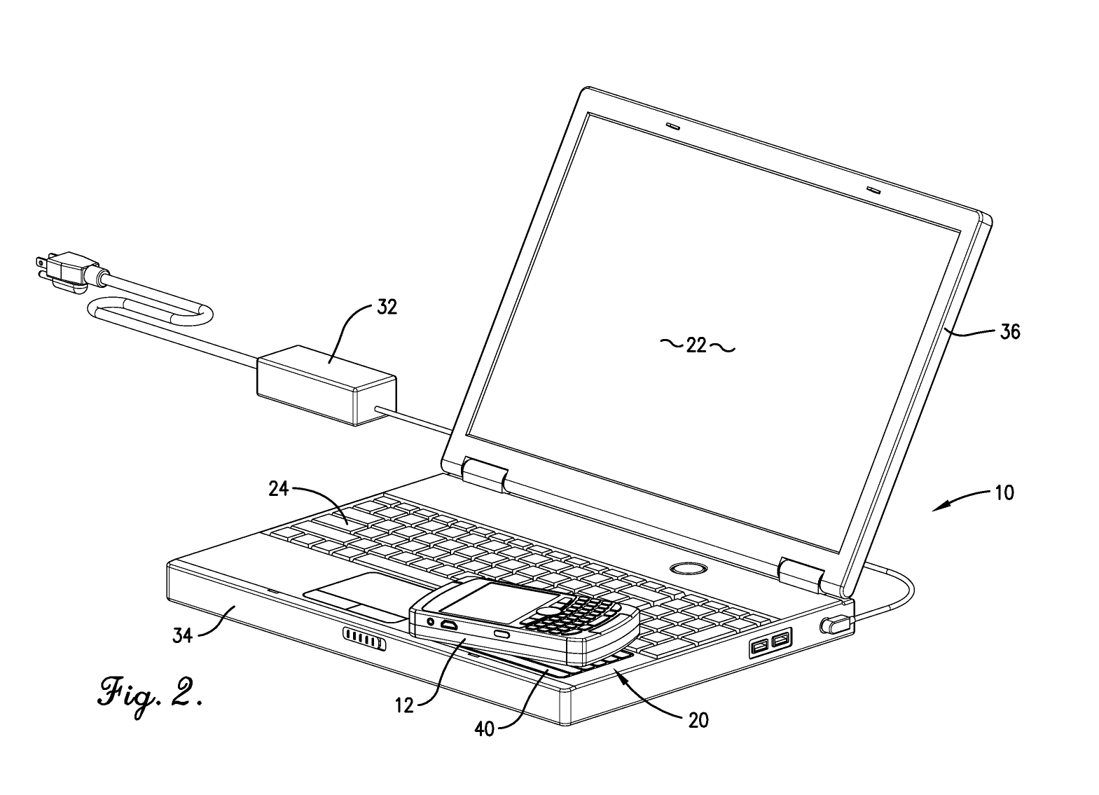

The inductive charging station 20 may be positioned anywhere on or in the housing 18. In various embodiments illustrated in FIGS. 1 and 2, the inductive charging station 20 may be integrated into a top surface of the base 34 below or adjacent the keyboard 24. With this configuration, the secondary electronic device 12 may be placed on and charged by the inductive charging station 20 while the cover 36 of the housing is opened. This permits a user to charge the batteries of the secondary electronic device 12 while using the primary electronic device 10 for its primary purpose, such as a laptop computer, etc.

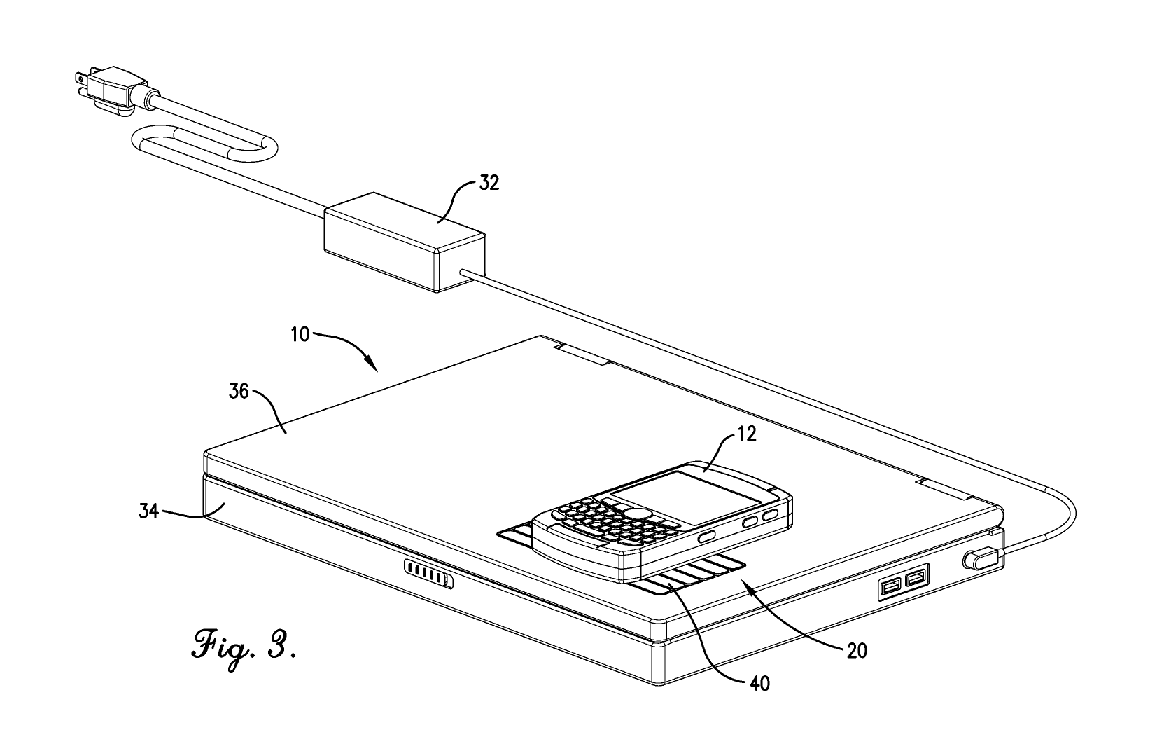

In other embodiments illustrated in FIG. 3, the inductive charging station 20 may be integrated into a top surface of the cover 36. With this configuration, the secondary electronic device 12 may be placed on and charged by the inductive charging station 20 while the cover 36 is closed. In still other embodiments, two or more inductive charging stations may be integrated into the housing 18 to provide several locations to charge the secondary electronic device 12. For example, a first inductive charging station may be integrated into the base 34 as illustrated in FIGS. 1 and 2, and a second inductive charging station may be integrated into the cover 36 as illustrated in FIG. 3.

The display screen 22 is operable to display visual graphics, images, text, etc. in response to external or internal processes and commands of the processor 14. The display screen 22 may comprise conventional black and white, monochrome, or color display elements including cathode ray tube (CRT), thin film transistor liquid crystal display (TFT-LCD), and/or light emitting diode (LED) display devices. In one embodiment, the display screen 22 is a LCD that is built into or otherwise supported by the cover 36 of the housing 18.

The keyboard 24 may be a conventional alphanumeric keyboard, and in one embodiment, is built into or otherwise attached to the base 34 of the housing 18. The keyboard 24 may be replaced with or supplemented by other user input devices such as a touchscreen display, mouse, track ball, etc.

The memory elements 26 may be any electronic memory that can be accessed by the processor 14 and operable for storing instructions or data. The memory elements 26 may be a single component or may be a combination of components that provide the requisite functionality. The memory elements 26 may include various types of volatile or non-volatile memory such as flash memory, optical discs, magnetic storage devices, SRAM, DRAM, or other memory devices capable of storing data and instructions. The memory elements may communicate directly with the processor, or they may communicate with the processor over the data bus 30 or other mechanism that facilitates direct or indirect communication between the devices. The memory elements may optionally be structured with a file system to provide organized access to data existing thereon.

The I/O ports 28 permit data and other information to be transferred to and from the primary electronic device 10. The I/O ports 28 may include a Secure Digital (SD) card slot, Mini SD Card slot, Micro SD Card slot or the like for receiving removable SD cards, Mini SD Cards, Micro SD Cards, or the like, and a USB port for coupling with a USB cable connected to another computing device.

As explained above, the secondary electronic device 12 may be charged or recharged by the primary electronic device 10 and may be any device with rechargeable batteries. Referring now to FIG. 5, an embodiment of the secondary electronic device 12 may comprise one or more processors 42 and/or other electronic circuitry for executing logical and mathematical operations on data; a battery or batteries 44 for powering the processor; a housing 46; and an inductive charger 48 attached to or integrally formed with the housing. The secondary electronic device 12 may also comprise a display 50; a keyboard 52; a communications component 54; a location determining component 56; one or more antennas 58; one or more memory elements 60; one or more input/output (I/O) ports 62; and/or other components.

In various embodiments, the secondary electronic device 12 may comprise a battery, a battery pack, a battery adapter, or the like for coupling with a third electronic device (e.g., a mobile phone, a portable electronic device, etc.). In such a configuration, the secondary electronic device 12 may comprise the battery 44 and inductive charger 48 without other components such as the display 50, the keyboard 52, the communications component 54, the location determining component 56, the antennas 58, the memory elements 60, the I/O ports 62, the processors 42, combinations thereof, and the like. Such configurations enable the secondary electronic device 12 to be charged as described herein and then separately coupled with the third electronic device without requiring the third electronic device to be placed in proximity to the primary electronic device 10.

The processor 42 may be any electronic device or component capable of executing logical and mathematical operations on data. The processor may be a single electronic component or it may be a combination of components that provide the requisite functionality. The processor may comprise a microprocessor, a microcontroller, programmable logic controller (PLC), field-programmable gate array (FPGA), application specific integrated circuit (ASIC), or any other component or components that are operable to perform, or assist in the performance of, the required operations. The processor may be coupled with other components of the electronic device through wired or wireless connections, such as a data bus 64, to enable information to be exchanged between the various components. However, the components of the secondary electronic device 12 need not be physically connected to one another since wireless communication among the various depicted components is permissible and intended to fall within the scope of the present invention.

The battery 44 provides electrical power to the other components of the secondary electronic device 12 and may comprise any type of rechargeable battery or batteries including lead acid, nickel cadmium (NiCad), nickel metal hydride (NiMHi), lithium ion (Li-ion) or lithium ion polymer (Li-ion polymer) batteries. The battery 44 may include any number of batteries, the size and rating of which may vary. The battery 44 may also comprise power conduits, connectors, receptacles, battery connectors, or power cables coupled with batteries.

The housing 46 may be handheld or otherwise portable to facilitate easy transport of the device 12. The housing may be constructed from a suitable lightweight and impact-resistant material such as, for example, plastic, nylon, aluminum, or any combination thereof and may include one or more appropriate gaskets or seals to make it substantially waterproof or resistant. The housing 46 may take any suitable shape or size, and the particular size, weight and configuration of the housing may be changed without departing from the scope of the present invention.

The inductive charger 48 is provided for charging the battery 44 when the secondary electronic device 12 is placed on or in the vicinity of the inductive charging station 20 of the primary electronic device 10. In various embodiments, the inductive charger 48 is built into or otherwise attached to the housing 46 of the secondary electronic device 12. As best illustrated in FIG. 6, the inductive charger 48 may include a secondary inductive coil 66 and a charging circuit 68 that is connected to the battery 44. The inductance value of the secondary inductive coil 66 may be selected to match or complement the inductance value of the primary inductive coil 38, but the present technology is not limited to any particular inductance values. Likewise, the power rating of the charging circuit 68 may be selected to match or complement the rating of the battery 44, but the present technology is not limited to any particular battery or charging circuit values. The inductive charger 48 may be built into the housing of the secondary electronic device 12 or may be contained in its own housing or back cover replacement for the secondary electronic device 12.

The display screen 50 is operable to display visual graphics, images, text, etc. in response to external or internal processes and commands of the processor 42. The display screen may comprise conventional black and white, monochrome, or color display elements including cathode ray tube (CRT), thin film transistor liquid crystal display (TFT-LCD), and/or light emitting diode (LED) display devices.

The keyboard 52 may be a conventional alphanumeric keyboard. The keyboard may be replaced with or supplemented by other user input devices such as a touchscreen display, mouse, track ball, etc.

The memory elements 60 may be any electronic memory that can be accessed by the processor 42 and operable for storing instructions or data. The memory elements 60 may be a single component or may be a combination of components that provide the requisite functionality. The memory elements may include various types of volatile or non-volatile memory such as flash memory, optical discs, magnetic storage devices, SRAM, DRAM, or other memory devices capable of storing data and instructions. The memory elements may communicate directly with the processor, or they may communicate with the processor over the bus or other mechanism that facilitates direct or indirect communication between the devices. The memory elements may optionally be structured with a file system to provide organized access to data existing thereon.

The communications component 54 enables the secondary electronic device 12 to communicate with other electronic devices through a communication network, such as a cellular phone network, the Internet, a local area network, a wide area network, and ad hoc or peer to peer network, or a direct connection such as a USB, Firewire, or Bluetooth™ connection, etc. The communications component 54 may communicate utilizing wireless data transfer methods such as WiFi (802.11), Wi-Max, Bluetooth™ ANT®, ultra-wideband, infrared, cellular telephony, radio frequency, etc. The communications component 54 may make and receive any communications including incoming and outgoing phone calls, text messages, instant message, voicemail messages, e-mail message, missed phone calls, and any other known communications. In one embodiment, the communications component 54 is a cellular transceiver for transmitting and receiving communications over a cellular phone network such as those operated by Sprint®, AT&T®, Verizon®, and other companies. The cellular phone network may operate with GSM (Global System for Mobile communications), CDMA (Code Division Multiple Access), or any other known standards.

The location determining component 56 determines locations of the secondary electronic device 12 as it is carried or otherwise moved from place to place. The location determining component may be a satellite navigation receiver that works with a global navigation satellite system (GNSS) such as the global positioning system (GPS) primarily used in the United States, the GLONASS system primarily used in the Soviet union, or the Galileo system primarily used in Europe.

The antennas 58 may include an antenna for the location determining component 56 to assist in receiving satellite signals and an antenna for the communications component 54 to assist in receiving and transmitting wireless communications. The antennas may be patch antennas, linear antennas, or any other type of antennas.

The I/O ports 62 permit data and other information to be transferred to and from the secondary electronic device 12. The I/O ports 62 may include a Secure Digital (SD) card slot, Mini SD Card slot, Micro SD Card slot or the like for receiving removable SD cards, Mini SD Cards, Micro SD Cards, or the like, and a USB port for coupling with a USB cable connected to another computing device such as a personal computer. Navigational software, cartographic maps and other data and information may be loaded in the electronic device via the I/O ports.

The above-described primary electronic device 10 and secondary electronic device 12 provide numerous advantages. For example, the secondary electronic device 12 may be conveniently charged or recharged by simply placing it on or near the inductive charging station 20 of the primary electronic device 10. Because the inductive charging station 20 of the primary electronic device 10 is electrically coupled with its power source 16, it may charge or recharge the secondary electronic device 12 without directly connecting either the inductive charging station 20 or the secondary electronic device 12 to an electrical socket or other source of power. Moreover, the inductive charging station 20 may be powered by the primary electronic device's internal batteries, so even the primary electronic device 10 may be disconnected from an external source of power while the secondary electronic device is being charged or recharged. Also, because the primary electronic device 10 has other functionalities such as those provided by a laptop computer, desktop computer, notepad computer, etc., it may be used for purposes other than just charging the secondary electronic device 12. This permits a user to quickly and conveniently charge a mobile phone or other secondary electronic device 12 without plugging it in and without using a dedicated stand-alone inductive charger.

Although the invention has been described with reference to the preferred embodiment illustrated in the attached drawing figures, it is noted that equivalents may be employed and substitutions made herein without departing from the scope of the invention as recited in the claims.

What is claimed is:

1. An electronic device comprising:
electronic circuitry for performing logical operations on data;
a power source for powering the electronic circuitry;
a housing for housing or supporting the electronic circuitry and the power source; and
an inductive charging station attached to or integrally formed with the housing and electrically coupled with the power source for inductively charging a battery of a secondary electronic device when the secondary electronic device is placed on or in the vicinity of the inductive charging station.

2. The electronic device as set forth in claim 1, wherein the inductive charging station comprises an induction coil positioned within the housing and coupled with the power source and a pad covering the induction coil for supporting the secondary electronic device thereon while it is being charged.

3. The electronic device as set forth in claim 1, wherein the housing includes a base hingedly connected to a cover, the cover being shiftable between opened and closed positions.

4. The electronic device as set forth in claim 3, wherein the inductive charging station is positioned within a top surface of the base so that the secondary electronic device may be placed on and charged by the inductive charging station when the cover of the housing is opened.

5. The electronic device as set forth in claim 3, wherein the inductive charging station is positioned within a top surface of the cover so that the secondary electronic device may be placed on and charged by the inductive charging station when the cover of the housing is closed.

6. The electronic device as set forth in claim 3, the electronic device further comprising a keyboard integrated into the base of the housing and a display screen integrated into the cover of the housing.

7. The electronic device as set forth in claim 6, wherein the inductive charging station is positioned on a top surface of the base below the keyboard.

8. The electronic device as set forth in claim 1, wherein the electronic device is a laptop computer, a desktop computer, a notepad computer, a television, a computer monitor, or a media player.

9. The electronic device as set forth in claim 1, wherein the secondary electronic device is a cell phone, a portable navigation device, a battery pack, or a portable media player.

10. A portable computer comprising:
a processor for performing logical operations on data;
memory coupled with the processor for storing the data;
an internal power source for powering the processor;
a housing for housing or supporting the electronic circuitry and the power source;
a keyboard positioned within the housing;
a display screen positioned within the housing; and
an inductive charging station attached to or integrally formed within the housing and electrically coupled with the power source for inductively charging a battery of a secondary electronic device when the secondary electronic device is placed on the inductive charging station.

11. The electronic device as set forth in claim 10, wherein the secondary electronic device is a cell phone, a portable navigation device, a battery pack, or a portable media player.

12. The electronic device as set forth in claim 10, wherein the housing comprises a base hingedly connected to a cover.

13. The electronic device as set forth in claim 12, wherein the inductive charging station is attached to or integrally formed with the base of the housing adjacent the keyboard.

14. A system comprising:
a primary electronic device comprising
electronic circuitry,
a power source for powering the electronic circuitry,
a housing for housing or supporting the electronic circuitry and the power source; and
an inductive charging station attached to or integrally formed with the housing, the inductive charging station including a primary induction coil electrically coupled with the power source; and
a secondary electronic device comprising
electronic circuitry,
a battery for powering the electronic circuitry, and
a secondary induction coil coupled with the battery for recharging the battery when the secondary electronic device is placed on or in the vicinity of the inductive charging station of the primary electronic device.

15. The system as set forth in claim 14, wherein the inductive charging station of the primary electronic device further comprises a pad for covering the primary induction coil and for supporting the secondary electronic device thereon while it is being charged.

16. The system as set forth in claim 14, wherein the housing of the primary electronic device includes a base hingedly connected to a cover.

17. The system as set forth in claim 16, wherein the inductive charging station is positioned within a top surface of the base so that the secondary electronic device may be placed on the inductive charging station when the cover of the housing is opened.

18. The system as set forth in claim 16, wherein the inductive charging station is positioned within a top surface of the cover so that the secondary electronic device may be placed on the inductive charging station when the cover of the housing is closed.

19. The system as set forth in claim 16, the primary electronic device further comprising a keyboard integrated into the base of the housing and a display screen integrated into the cover of the housing.

20. The system as set forth in claim 19, wherein the inductive charging station is positioned within a top surface of the base below the keyboard.
